(19) United States
(12) Patent Application Publication
(10) Pub. No.: US 2014/0330894 A1
(43) Pub. Date: Nov. 6, 2014

(54) METHOD, TERMINAL AND SYSTEM FOR IMPLEMENTING DATA SHARING

(71) Applicant: TENCENT TECHNOLOGY (SHENZHEN) COMPANY LIMITED, Shenzhen (CN)

(72) Inventors: Weifeng Zhao, Shenzhen (CN); Shenyuan Li, Shenzhen (CN); Huande Zheng, Shenzhen (CN)

(73) Assignee: TENCENT TECHNOLOGY (SHENZHEN) COMPANY LIMITED, Shenzhen (CN)

(21) Appl. No.: 14/333,054

(22) Filed: Jul. 16, 2014

Related U.S. Application Data
(63) Continuation of application No. PCT/CN2013/088321, filed on Dec. 2, 2013.

(30) Foreign Application Priority Data
Jan. 29, 2013 (CN) 201310033202.1

(51) Int. Cl. H04L 29/08

(52) U.S. Cl. CPC H04L 67/10
USPC 709/203

(57) ABSTRACT

A method, a terminal, and a system for implementing data sharing are described. The method includes: obtaining identification information of data to share stored in a server; allocating at least one identification frequency for the identification information according to a preset frequency allocation rule, creating an identification audio signal according to the at least one identification frequency; and playing the created identification audio signal, so that a receiver downloads the data to share from the server according to the identification information in the identification audio signal after the receiver collects the identification audio signal. In the disclosure, transmitting identification information of the data to share for data sharing may be performed anytime and anywhere as long as a connection with the server has been established, without the need of establishing a Bluetooth or other connections between the terminals or the need of installing any communication applications.

### CROSS REFERENCE TO RELATED APPLICATIONS

This application is a U.S. continuation application under U.S.C. §111(a) claiming priority under U.S.C. §§120 and 365(c) to International Application No. PCT/CN2013/088321, filed on Dec. 2, 2013, which claims the priority benefit of Chinese Patent Application NO. 201310033202.1, filed on Jan. 29, 2013, the content of which is hereby incorporated by reference in its entire for all purposes.

### FIELD OF THE TECHNICAL

The disclosure relates to the field of computer, and particularly to a method, a terminal and a system for implementing data sharing.

### BACKGROUND

This section provides background information related to the present disclosure which is not necessarily prior art.

Data sharing refers to joint management and sharing of data and/or information in a server between different terminals (including handsets, panel computers, etc.) through a network (including a local area network and internet). A terminal is able to share audio, video, images, articles or other information to another terminal by data sharing.

In the existing art, a data connection needs to be established between two terminals when performing data sharing. A terminal which launches data sharing will transmit link information of audio/video, etc. to another terminal. For example, the link information is transmitted by Bluetooth, or by a communication application performing data reception and transmission after connected to the internet. If the data connection cannot be established, it is relatively difficult to perform data sharing, or it is only practical to inform the other person of the link information orally so as to download the data to share from a corresponding server. These bring users relatively great inconvenience and are unfavorable for the development and popularization of data sharing.

### SUMMARY

Exemplary embodiments of the present invention provide a method, a terminal and a system for implementing data sharing, in which transmission of identification information of data to share such as audio/video can be performed with playing modules and sound collecting modules of handsets, computers and other terminals, and implementing data sharing simply.

One embodiment of the invention provides a method for implementing data sharing, comprising: obtaining identification information of data to share stored in a server; allocating at least one identification frequency for the identification information according to a preset frequency allocation rule, creating an identification audio signal according to the at least one identification frequency; and playing the created identification audio signal, so that a receiver downloads the data to share from the server according to the identification information in the identification audio signal after the receiver collects the identification audio signal.

Another embodiment of the invention provides a method for implementing data sharing, comprising: determining at least one identification frequency of an identification audio signal in sequence when collecting the identification audio signal; analyzing and determining identification information carried by the identification audio signal according to the at least one identification frequency and a preset frequency allocation rule; and transmitting a download request carrying the analyzed and determined identification information to a server storing data to share, downloading the data to share corresponding to the identification information from the server.

Yet another embodiment of the invention provides a method for implementing data sharing, comprising: obtaining, at a transmitter, identification information of data to share stored in a server, allocating at least one identification frequency for the identification information according to a preset frequency allocation rule, creating and playing an identification audio signal according to the at least one identification frequency; obtaining, at a receiver, the identification information by analyzing the identification audio signal according to the preset frequency allocation rule after the receiver collects the identification audio signal, and transmitting a download request carrying the identification information to the server; and searching, at the server, target data corresponding to the identification information carried in the download request when the server receives the download request, and transmitting the searched target data to the receiver.

Yet another embodiment of the invention provides a terminal for implementing data sharing, comprising: an obtaining module, which is configured to obtain identification information of data to share stored in a server; a creating module, which is configured to allocate at least one identification frequency for the identification information according to a preset frequency allocation rule, and create an identification audio signal according to the at least one identification frequency; and a playing module, which is configured to play the created identification audio signal, so that a receiver downloads the data to share from the server according to the identification information in the identification audio signal after the receiver collects the identification audio signal.

Yet another embodiment of the invention provides a terminal for implementing data sharing, comprising: a determining module, which is configured to determine at least one identification frequency of an identification audio signal in sequence when collecting the identification audio signal; an analyzing module, which is configured to analyze and determine identification information carried by the identification audio signal according to the at least one identification frequency and a preset frequency allocation rule; and a request module, which is configured to transmit a download request carrying the analyzed and determined identification information to a server storing data to share, and download the data to share corresponding to the identification information from the server.

Yet another embodiment of the invention provides a system for implementing data sharing, comprising a transmitter, a receiver, and a server, wherein: the transmitter, which is configured to obtain identification information of data to share stored in a server, allocate at least one identification frequency for the identification information according to a preset frequency allocation rule, and create and play an identification audio signal according to the at least one identification frequency; the receiver, which is configured to obtain the identification information by analyzing the identification audio signal according to the preset frequency allocation rule after the receiver collects the identification audio signal, and transmit a download request carrying the identification information to the server; and the server, which is configured to search target data corresponding to the identification information carried in the download request when the server receives the download request, and transmit the searched target data to the receiver.

Exemplary embodiments of the present invention may have the following benefit effects.

According to various embodiments, the identification information corresponding to the data to share can be played as an audio signal to other terminals, so as to accomplish transmission of the identification information of the data to share. In this way, data sharing may be performed anytime and anywhere as long as a connection with the server has been established, without the need of establishing a Bluetooth or other connections between the terminals or the need of installing any communication applications. Therefore, data such as audio/video, image/photograph, and article/fiction can be shared in a real-time, fast, and convenient way.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a method for implementing data sharing according to one embodiment of the invention;

FIG. 2 is a flowchart of a method for implementing data sharing according to another embodiment of the invention;

FIG. 3 is a flowchart of a method for implementing data sharing according to yet another embodiment of the invention;

FIG. 4 is a structure diagram of a terminal for implementing data sharing according to yet another embodiment of the invention;

FIG. 5 is a structure diagram of a creating module according to yet another embodiment of the invention;

FIG. 6 is a structure diagram of a creating module according to yet another embodiment of the invention;

FIG. 7 is a structure diagram of a creating module according to yet another embodiment of the invention;

FIG. 8 is a structure diagram of an obtaining module according to yet another embodiment of the invention;

FIG. 9 is a structure diagram of a terminal for implementing data sharing according to yet another embodiment of the invention;

FIG. 10 is a structure diagram of an analyzing module according to yet another embodiment of the invention;

FIG. 11 is a structure diagram of an analyzing module according to yet another embodiment of the invention;

FIG. 12 is a structure diagram of an analyzing module according to yet another embodiment of the invention;

FIG. 13 is a structure diagram of a terminal for implementing data sharing according to yet another embodiment of the invention;

FIG. 14 is a structure diagram of a system for implementing data sharing according to yet another embodiment of the invention;

FIG. 15 depicts an exemplary environment incorporating certain disclosed embodiments; and

FIG. 16 depicts an exemplary computing system consistent with the disclosed embodiments.

### DETAILED DESCRIPTION OF ILLUSTRATED EMBODIMENTS

The following in conjunction with the accompanying drawings according to various embodiments, clearly describes technical proposals according to various embodiments. It would be obvious that the described embodiments are part but not all of embodiments. All other embodiments obtained by persons having ordinary skills without paying any creative work based on the illustrated embodiments should all be within the protection scope according to various embodiments.

FIG. 15 depicts an exemplary environment 1500 incorporating exemplary methods and systems for implementing data sharing in accordance with various disclosed embodiments. As shown in FIG. 15, the environment 1500 may include a server 1502, a terminal 1504, and a communication network 1506. The server 1502 and the terminal 1504 may be coupled through the communication network 1506 for information exchange including, e.g., sending/receiving identification information of data to share, download requests, target data, etc. Although only one server 1502 and one terminal 1504 are shown in the environment 1500, any number of servers 1502 or terminals 1504 may be included, and other devices may also be included.

The communication network 1506 may include any appropriate type of communication network for providing network connections to the server 1502 and the terminal 1504 or among multiple servers 1502 or terminals 1504. For example, the communication network 1506 may include Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., receiving download requests, searching data, sending target data, etc. A server may also include one or more processors to execute computer programs in parallel.

The server 1502 and the terminal 1504 may be implemented on any appropriate computing platform. FIG. 16 shows a block diagram of an exemplary computing system 1600 (or computer system 1600) capable of implementing the server 1502 and/or the terminal 1504. As shown in FIG. 16, the exemplary computer system 1600 may include a processor 1602, a storage medium 1604, a monitor 1606, a communication module 1608, a database 1610, peripherals 1612, and one or more bus 1614 to couple the devices together. Certain devices may be omitted and other devices may be included.

The processor 1602 can include any appropriate processor or processors. Further, the processor 1602 can include multiple cores for multi-thread or parallel processing. The storage medium 1604 may include memory modules, e.g., Read-Only Memory (ROM), Random Access Memory (RAM), and flash memory modules, and mass storages, e.g., CD-ROM, U-disk, removable hard disk, etc. The storage medium 1604 may store computer programs for implementing various processes (e.g., receiving identification information, processing the identification information, etc), when executed by the processor 1602.

The monitor 1606 may include display devices for displaying contents in the computing system 1600, e.g., displaying videos, images, photographs, etc. The peripherals 1612 may include I/O devices such as keyboard and mouse.

Further, the communication module 1608 may include network devices for establishing connections through the communication network 1506. The database 1610 may include one or more databases for storing certain data and for performing certain operations on the stored data, e.g., storing the identification information of data to share or any other suitable data, searching and management operations.

In operation, the terminal 1504 may cause the server 1502 to perform certain actions, e.g., receiving the download requests, searching the target data corresponding to the identification information carried in the download requests, and transmitting the searched target data, etc. The server 1502 may be configured to provide structures and functions for such actions and operations. More particularly, the server 1502 may include a management server or any other suitable servers for corresponding functions.

In various embodiments, a terminal involved in the disclosed methods and systems can include the terminal 1504, while a server involved in the disclosed methods and systems can include the server 1502. The methods and systems disclosed in accordance with various embodiments can be executed by a computer system. In one embodiment, the disclosed methods and systems can be implemented by a server.

Various embodiments provide methods and systems for implementing data sharing. The methods and systems are illustrated in various examples described herein.

In the specification, when identification information is transformed to obtain an audio signal, the identification information will be transformed into a number of different types of data sequentially and finally arrive at the audio signal, and vice versa. Such different types of data include, but not limited to, characters, frequencies, character numbers, frequency numbers, etc. These different types of data may be named with “identification” ahead to avoid confusing with other elements having the same names, for example, frequencies, characters in an allocating rule. Thus, they may be named as “identification characters”, “identification frequencies”, “identification character numbers”, “identification frequency numbers”, etc. However, when described in details, the “identification” may be omitted for simplification. If a person having ordinary skills would understand that a certain type of data, for example, a frequency, is obtained as intermediate or final data during the transformation of the identification information to the audio signal and vice versa, it will be clear that it is substantially the same as a feature having an identical name but with “identification” ahead, for example, “identification frequency.”

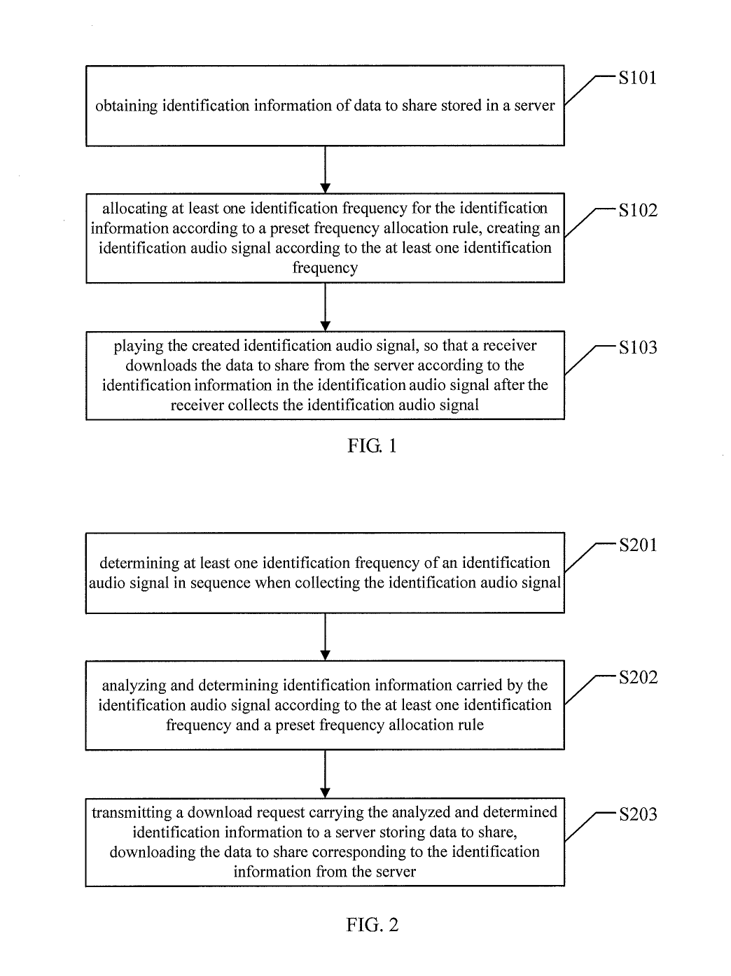

As shown in FIG. 1, it is a flowchart of a method for implementing data sharing according to one embodiment of the invention. The method can be used in handsets, computers and other terminals. When a terminal needs sharing data stored in a server to other terminals as a transmitter, the terminal can implement the data sharing by the method according to this embodiment, which comprises the following steps.

Step S101 is: obtaining identification information of data to share stored in a server.

The server can be an audio/video server, an image/photograph server, a literature/fiction server, and other kinds of servers. The server stores various kinds of data files, including a number of audio/video files, image/photograph files, and literature/fiction files, and unique identification information is allocated for each of these files. The identification information can be a short character string of N bits. Specifically, in the server, the identification information corresponding to each file may be obtained by a hash algorithm based on key words of the file.

If a terminal user needs to share the audios/videos, images/photographs, and literature/fictions with other users after the terminal user has downloaded and browsed them, the terminal user will go to the corresponding server to obtain identification information corresponding to these files according to link addresses and/or topic names and other information of the audios/videos, images/photographs, and literature/fictions that the terminal user wants to share.

Step S102 is: allocating at least one identification frequency for the identification information according to a preset frequency allocation rule, creating an identification audio signal according to the at least one identification frequency.

That is, a terminal such as a handset and a computer converts the identification information into frequency according to the preset frequency allocation rule, so that an obtained audio signal is played with a speaker of the handset, computer, or other terminals.

The obtained identification information is character identification information, which may include numeric symbols from 1 to 9, letter symbols from a to z and A to Z. Certainly, the character identification information may also only include numeric symbols from 1 to 9, etc. There are three following manners to concretely implement the creation of the identification audio signal in step S102.

The first manner is: determining at least one identification frequency each corresponding to a respective one of the at least one identification character according to a one-to-one mapping relationship between characters and frequencies in the preset frequency allocation rule to obtain frequency information of the identification information; and creating the identification audio signal according to the obtained frequency information.

That is, in a mapping table related to the characters and frequencies, the stored characters are mapped to corresponding frequencies in a one-to-one manner. After obtaining the identification information, for each of the characters in the identification information, its corresponding frequency is searched for. Then, the identification audio signal carrying the identification information is obtained according to all of the frequencies obtained by searching.

The identification audio signal created according to respective frequency values of all characters may be obtained by using a sine or cosine calculation. For example, the way of using a sine calculation to create the identification audio signal may be as below.

As for a function s(n)=sin(2*pi*fi*n/fs+ph0), in which “s(n)” stands for a created audio signal, and “n” is a No. n sampling point. The “fi” stands for a No. i frequency signal, the “fs” stands for a sampling rate of the digital signal, and the “ph0” stands for an initial phase offset. Furthermore, the corresponding frequencies of adjacent character can be spaced at a certain frequency interval to guarantee that a receiver can be able to obtain corresponding characters by effectively distinguishing different frequencies.

The second manner is: allocating a combined identification frequency for each of the at least one identification character according to a mapping relationship between character numbers and frequency numbers in the preset frequency allocation rule to obtain frequency information of the identification information, the combined identification frequency being obtained by combining at least two frequencies; and creating the identification audio signal according to the obtained frequency information.

That is, the corresponding relationship between characters and frequencies is determined by a corresponding relationship between numbers assigned to them. A number of a character may be obtained by combining respective numbers of two frequencies. The specific manner of combining may be adding them together.

Specifically, if 31 frequencies are used to represent frequencies for 61 characters, a manner of 0+N with 30+N to represent all 61 characters may be adopted. For example, 11 can be represented as 0+11. That is, a character with a number of 11 can be represented by a combination of two frequencies whose numbers are 0 and 11, respectively, while 54 can be represented by 30+24.

If 1-9, a-z, and A-Z are numbered in sequence from number 1, the character having number 54 is R. The number 54 can be divided into 30+23. That is, the character R having the number 54 can correspond to a combination of two frequencies whose numbers are 30 and 23, respectively. Two frequencies whose numbers are respectively 30 and 23 are combined when performing audio signal conversion for Z included in the identification information. Similarly, each character may be obtained by combining 4 or 8 frequencies.

A sine or cosine calculation may be adopted to obtain the identification audio signal corresponding to the identification information after the correspondence relationship between the corresponding characters and frequency combinations is obtained. Compared with the first manner, in the second manner, a longer audio signal will be obtained. However, it is found in a practical test that since the adopted frequencies are fewer in the second manner, the receiver can obtain the identification information by analyzing the identification audio signal more simply and more accurately.

The third manner is: obtaining at least one identification character number each corresponding to a respective one of the at least one identification character according to a one-to-one mapping relationship between characters and character numbers in the preset frequency allocation rule, and then obtaining a binary code string by combining at least one binary code each converted by a respective one of the at least one identification character number; dividing the binary code string into at least one portion of the binary code string according to a preset coding number threshold value, and converting the at least one portion of the binary code string into at least one identification frequency number each corresponding to a respective one of the at least one portion of the binary code string; obtaining frequency information of the identification information according to the at least one identification frequency number and frequency numbers in the preset frequency allocation rule; and creating the identification audio signal according to the obtained frequency information.

That is, according to the character numbers, a corresponding frequency is determined by encoding in the manner of recombining binary codes. Specifically, if 16 frequencies are used to represent frequencies of 61 characters, after numbering 1-9, a-z, and A-Z in sequence from number 0, the numbers for all characters in the identification information are converted into binary codes, which are then re-evaluated and re-sorted to obtain new numbers, and the new numbers will correspond to the numbers of frequencies. For example, 6 bits are needed to represent 61 characters while 16 frequencies are only able to represent 4 bits. Therefore, the excess bits and the first two bits of a following character are combined together to obtain another new number. For an identification information a5B7, the binary codes obtained according to the character numbers are: 001010 000101 100110 000111. By setting the coding number threshold value as 4, the above string of binary codes is divided and the following binary codes are obtained: 0010 1000 0101 1001 1000 0111, which is converted again into a hexadecimal number of 285987. That is, frequencies having numbers of 2, 8, 5, 9, 8 and 7, respectively, are obtained as the corresponding frequencies. Then, a sine or cosine calculation is performed on the frequencies corresponding to the above numbers, and an identification audio signal carrying the identification information is obtained. Compared with the first manner, in the third manner, a longer audio signal will be obtained. However, it is found in a practical test that since the adopted frequencies are even fewer in the third manner, the receiver can obtain the identification information by analyzing the identification audio signal more simply and more accurately.

It should be noted that, if the figures in the string of binary codes obtained by converting the characters of the identification information does not have a number that is an integer multiple of the coding number threshold value, noughts may be added into the string to make the number of figures to be an integral multiple of the coding number threshold value. For example, if the identification information is a5B71, the corresponding string of binary codes is 001010 000101 100110 000111 000001. When the string is divided by the number threshold value 4, binary codes as 0010 1000 0101 1001 1000 0111 0000 0100 are obtained, and the last two bits 00 is automatically added.

In addition, before performing the conversion process in the above three manners, a binary compression may be performed on the character string of the identification information. Then, the conversion from characters to frequencies in the first, second, or the third manners may be performed on the compressed character string.

Step S103 is: playing the created identification audio signal, so that a receiver downloads the data to share from the server according to the identification information in the identification audio signal after the receiver collects the identification audio signal.

The identification audio signal is played by speaker equipments of handsets, computers, or other terminals. After a receiver equipment collects the identification audio signal by a microphone or other sound collecting modules, a process such as filtering may be firstly performed on the identification audio signal to remove noise from it. Secondly, the signal period and frequencies may be determined by sampling. Thirdly, characters may be obtained according to the frequencies, and then the identification information may be obtained. Fourthly, erroneous frequencies are corrected by a check, and meanwhile, the signal is ensured to be accurate and judged as identification information. Finally, according to the identification information, data such as audio/video, image/photograph, and literal/fiction corresponding to the identification information are downloaded from the server.

Furthermore, in one embodiment, after obtaining the corresponding frequencies of the characters in the step S102, when generating the identification audio signal, the identification audio signal may be created according to a preset audio format and the obtained frequency information. Wherein, the preset audio format comprises an identifier, an information bit, and a check bit, the identifier is used to identify that an audio signal is the identification audio signal carrying the identification information, the information bit is used to carry the frequency information, and the check bit is used for error correction check for the identification audio signal. The identifier, the information bit, and the check bit are set at specified positions of the identification audio signal. Their relative positions may be determined by negotiation between the transmitter and the receiver.

The identifier may be set in a head section of the identification audio signal; or the identifier may be divided into two sections, which are respectively set in the head section and the tail section of the identification audio signal; or the identifier may be divided into two sections, which are respectively set in the head section and the middle section of the identification audio signal.

In one embodiment of the invention, by converting the identification information corresponding to the data to share into an audio signal to play to other terminals, data sharing may be performed anytime and anywhere as long as a connection with the server has been established, without the need of establishing a bluetooth or other connections between the terminals or the need of installing any communication applications. Therefore, data such as audio/video, image/photograph, and article/fiction can be shared in a real-time, fast, and convenient way.

As shown in FIG. 2, it is a flowchart of a method for implementing data sharing according to another embodiment of the invention. The method can be used in handsets, computers and other terminals. When a terminal as a receiver needs to receive data which is stored in a server and shared by other terminals, the terminal can download and receive the data to be shared by the method according to one embodiment of the invention. Specifically, the method in one embodiment may comprise the following steps.

Step S201 is: determining at least one identification frequency of an identification audio signal in sequence when collecting the identification audio signal.

When a handset, a computer, etc. serves as a receiver, after it collects an identification audio signal by a microphone or other sound collecting module, each frequency of the identification audio signal is determined in sequence by means of filtering, sampling, etc.

Specifically, the receiver firstly analyzes and searches for an identifier in an audio signal according to a signal format that has been agreed by negotiating with the transmitter. According to the identifier, the receiver determines whether the audio signal is an identification audio signal carrying identification information. That is, before analyzing and determining the identification information carried by the identification audio signal according to each frequency of the identification audio signal and a preset frequency allocation rule, the method further comprises the following steps.

Judging whether an identifier is obtained after analyzing a frequency segment of an identifier bit in the at least one identification frequency, the identifier being used for identifying that an audio signal is the identification audio signal carrying the identification information. That is, a collected audio data section is checked in real time. The identifier is searched according to a negotiated arrangement placement segment. And according to frequencies of the arrangement placement segment, the receiver determines whether the identifier is an negotiated identifier.

If the identifier is obtained, obtaining check bit information by analyzing one of the at least one identification frequency that corresponds to the check bit, and checking the identification audio signal by a preset checksum algorithm and by the check bit information. If the identifier is not obtained, the identification audio signal will be discarded and a collection will be performed on an audio signal again. Correspondingly, a check bit may be searched according to the negotiated arrangement placement segment. A check performed on the identification audio signal by the check character is determined according to the frequencies of the arrangement placement segment.

If the check succeeds, performing the step of analyzing and determining the identification information carried by the identification audio signal according to the at least one identification frequency and a preset frequency allocation rule. If the check fails, the identification audio signal will be discarded and a collection will be performed on an audio signal again.

Certainly, the receiver, such as a handset and a computer, can analyze any received audio signal in another embodiment. When a short string of N bits can be obtained by analyzing, the audio signal will be determined as identification audio information. When the audio signal cannot be analyzed or a short string of N bits cannot be obtained by analyzing, the audio signal will be discarded or treated as data for other functions and transmitted to other functional modules.

After the check succeeds, the frequencies of the agreed and specified position segment can be determined. The frequencies may be determined by the following calculations.

For a sinusoidal signal sin(n), if the number of sampling points is N, the sampling rate is fs, the zero-crossing rate is c in a duration oft, the number of peaks is p, the corresponding frequency should be: f=c*fs/2/N or f=p*fs/N.

For the sinusoidal signal, the zero-crossing rate c is determined by how many there are pairs of adjacent sampling points whose product is negative. The peak is a sampling point whose value is greater than both of its former point and its latter point. By calculating values of c and p for N successive sampling points in a duration, the corresponding frequency may be obtained according to the above formula f=c*fs/2/N or f=p*fs/N.

Furthermore, for the obtainment of the frequency value f, interference may be removed in the following ways: band-pass filters are set anteriorly and posteriorly to remove interference of noise; a median filtering process is performed on the anterior and posterior segments of the frequency to remove interference of noise; or a pitch period detection in audio is adopted instead of the zero-crossing rate detection and peak detection.

Step S202 is: analyzing and determining identification information carried by the identification audio signal according to the at least one identification frequency and a preset frequency allocation rule.

Correspondingly, as those for the transmitter to convert characters into frequencies, the receiver can convert frequencies into characters in the following three analyzing manner.

The first manner is: determining in sequence the at least one identification character each corresponding to a respective one of the at least one identification frequency according to a one-to-one mapping relationship between characters and frequencies in the preset frequency allocation rule; and obtaining the identification information according to the at least one identification character.

That is, according to the calculated frequencies, characters that each standing for a respective one of the frequencies is searched in sequence. Thus, each character is determined, and thereby the identification information is obtained.

The second manner is: determining in sequence at least one identification frequency number each corresponding to a respective one of the at least one identification frequency according to frequency numbers in the preset frequency allocation rule; obtaining at least one identification character number each by making a sum of at least two of the identification frequency numbers, and determining in sequence at least one identification characters each corresponding to a respective one of the at least one identification character number according to a one-to-one mapping relationship between characters and character numbers in the preset frequency allocation rule; and obtaining the identification information according to the at least one identification character.

Firstly, a number for each of the calculated frequencies is obtained. Secondly, by adding two or four of the numbers together, a new number is obtained. Thirdly, a character is obtained according to the new number. For example, when numbers 30 and 23 corresponding to the first frequency and the second frequency, respectively, are obtained, 54 will be obtained by adding 30 and 23 according to an agreement with the transmitter. Therefore, it can be determined that the corresponding character of the two frequencies is character R whose number is 54. Similarly, other characters can be obtained.

The third manner is: determining in sequence at least one identification frequency number each corresponding to a respective one of the at least one identification frequency according to a one-to-one mapping relationship between frequencies and frequency numbers in the preset frequency allocation rule; converting the at least one identification frequency number into at least one binary code each corresponding to a respective one of the at least one identification frequency number, obtaining a binary code string by combining the at least one binary code, dividing the binary code string into at least one portion of the binary code string according to a preset decoding number threshold value, and converting the at least one portion of the binary code string into at least one identification character number each corresponding to a respective one of the at least one portion of the binary code string; determining in sequence at least one identification character each corresponding to a respective one of the at least one identification character number according to a one-to-one mapping relationship between characters and character numbers in the preset frequency allocation rule; and obtaining the identification information according to the at least one identification character.

That is, according to the corresponding numbers of the calculated frequencies, numbers of corresponding characters can be determined by renumbering in a manner of recombining binary codes. For example, when it is determined that frequencies of information bits in the collected identification frequency signal are those whose numbers are 2, 8, 5, 9, 8 and 7, respectively, these numbers are converted into binary codes as: 0010 1000 0101 1001 1000 0111. Then, according to the decoding number threshold value 6 appointed in an agreement with the transmitter, the following binary codes may be determined: 001010 000101 100110 000111. Therefore, it can be determined that the characters of the identification information are a5B7. Correspondingly, if noughts are added at the transmitter as needed, one or more noughts in the tail section will also be removed at the receiver according to the agreement to obtain the correct characters.

Furthermore, if at the transmitter, a binary compression is performed the character string of the identification information before converting the identification information into frequencies, obtaining the identification information according to the at least one identification character will comprises: obtaining a decompressed character string by implementing a binary decompression on a character string obtained by combining the at least one identification character, wherein the decompressed character string serves as the character identification information. As to whether to perform the binary compression process, a mark may be inserted at a specified position when the identification audio signal is created at the transmitter to notify the receiver that it is needed to perform the binary decompression. Otherwise, it can be appointed in an agreement that both binary compression and binary decompression will be previously performed, respectively.

Step S203 is: transmitting a download request carrying the analyzed and determined identification information to a server storing data to share, downloading the data to share corresponding to the identification information from the server.

A download request is transmitted to the server according to the identification information. The server searches for corresponding data to share, such as audio/video, image/photograph, and article/fiction, according to the identification information, and transmits the data to the receiver to accomplish data sharing through internet or other networks.

According to one embodiment, the receiver is able to analyze the received audio data and to download the data to share corresponding to the identification information at the server after the receiver obtains the identification information. In this way, data sharing may be performed anytime and anywhere as long as a connection with the server has been established, without the need of establishing a bluetooth or other connections between the terminals or the need of installing any communication applications. Therefore, data such as audio/video, image/photograph, and article/fiction can be shared in a real-time, fast, and convenient way.

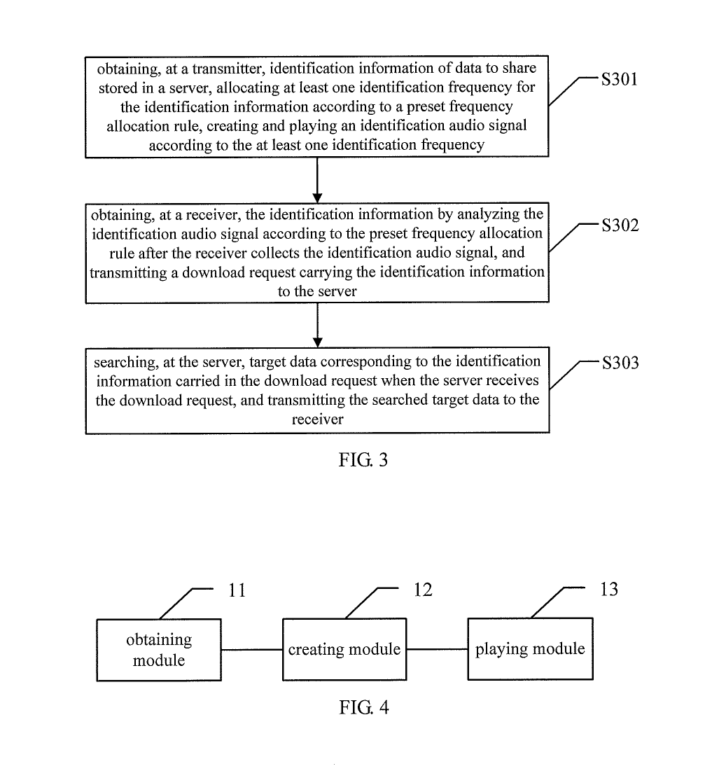

As shown in FIG. 3, it is a flowchart of a method for implementing data sharing according to yet another embodiment of the invention. The method may include the following steps.

Step S301 is, obtaining, at a transmitter, identification information of data to share stored in a server, allocating at least one identification frequency for the identification information according to a preset frequency allocation rule, creating and playing an identification audio signal according to the at least one identification frequency.

Step S302 is, obtaining, at a receiver, the identification information by analyzing the identification audio signal according to the preset frequency allocation rule after the receiver collects the identification audio signal, and transmitting a download request carrying the identification information to the server.

Step S303 is, searching, at the server, target data corresponding to the identification information carried in the download request when the server receives the download request, and transmitting the searched target data to the receiver.

Specifically, the methods for finally creating and playing, at the transmitter, the identification audio signal in the step S301 is the same as the methods described in embodiments corresponding to FIG. 1. The methods for downloading, at the server, the data to share after receiving the identification audio signal in the step S302 is the same as the methods described in the embodiment corresponding to FIG. 2. The server searches for data, such as audio/video, image/photograph, article/fiction, that correspond to the identification information by a search manner, and transmits the data to the receiver to accomplish data sharing through Internet or other networks.

According to one embodiment, the identification information corresponding to the data to share can be played as an audio signal to other terminals, so as to accomplish transmission of the identification information of the data to share. In this way, data sharing may be performed anytime and anywhere as long as a connection with the server has been established, without the need of establishing a bluetooth or other connections between the terminals or the need of installing any communication applications. Therefore, data such as audio/video, image/photograph, and article/fiction can be shared in a real-time, fast, and convenient way.

A terminal and a system for implementing data sharing according to the embodiment of the invention are described in detail in the following steps.

As shown in FIG. 4, it is a structure diagram of a terminal for implementing data sharing according to yet another embodiment of the invention. The terminal for implementing data sharing may be handsets, computers and other terminals having audio playback function. The terminal serving as a transmitter for implementing data sharing comprises: an obtaining module 11, which is configured to obtain identification information of data to share stored in a server; a creating module 12, which is configured to allocate at least one identification frequency for the identification information according to a preset frequency allocation rule, and create an identification audio signal according to the at least one identification frequency; and a playing module 13, which is configured to play the created identification audio signal, so that a receiver downloads the data to share from the server according to the identification information in the identification audio signal after the receiver collects the identification audio signal.

The obtained identification information is character identification information, which may include numeric symbols from 1 to 9, letter symbols from a to z and A to Z. Certainly, the character identification information may only include numeric symbols from 1 to 9, etc. The creating module 12 may comprise a structure shown in FIG. 5: a first determining unit 121, which is configured to determine at least one identification frequency each corresponding to a respective one of the at least one identification character according to a one-to-one mapping relationship between characters and frequencies in the preset frequency allocation rule to obtain frequency information of the identification information; and a first creating unit 122, which is configured to create the identification audio signal according to the obtained frequency information.

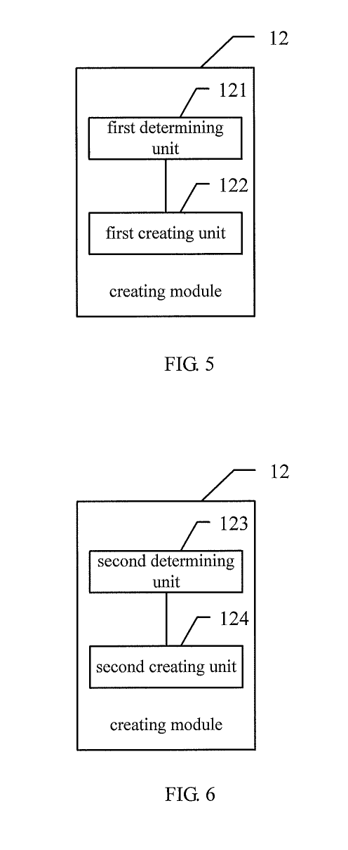

Optionally, the creating module 12 comprises a structure shown in FIG. 6: a second determining unit 123, which is configured to allocate a combined identification frequency for each of the at least one identification character according to a mapping relationship between character numbers and frequency numbers in the preset frequency allocation rule to obtain frequency information of the identification information, the combined identification frequency being obtained by combining at least two frequencies; and a second creating unit 124, which is configured to create the identification audio signal according to the obtained frequency information.

Still optionally, the creating module 12 may comprise a structure shown in FIG. 7: a converting unit 125, which is configured to obtain at least one identification character number each corresponding to a respective one of the at least one identification character according to a one-to-one mapping relationship between characters and character numbers in the preset frequency allocation rule, then obtain a binary code string by combining at least one binary code each converted by a respective one of the at least one identification character number, divide the binary code string into at least one portion of the binary code string according to a preset coding number threshold value, and convert the at least one portion of the binary code string into at least one identification frequency number each corresponding to a respective one of the at least one portion of the binary code string; a third determining unit 126, which is configured to obtain frequency information of the identification information according to the at least one identification frequency number and frequency numbers in the preset frequency allocation rule; and a third creating unit 127, which is configured to create the identification audio signal according to the obtained frequency information.

Furthermore, as to the creating module 12, when creating the identification audio signal according to the obtained frequency information, the identification audio signal is created according to a preset audio format and the obtained frequency information, wherein the preset audio format comprises an identifier, an information bit, and a check bit, the identifier is used to identify that an audio signal is the identification audio signal carrying the identification information, the information bit is used to carry the frequency information, and the check bit is used for error correction check for the identification audio signal.

The creating module 12 specifically performs the step of the above S102, which will not be described here to avoid redundancy. Meanwhile, the creating module 12 in the terminal for implementing data sharing in embodiments of the invention may comprise a structure shown in any one of FIGS. 5-7, so that a conversion of characters into frequencies can be performed by selecting corresponding functional units of the creating module 12 according to needs of the user at the receiver.

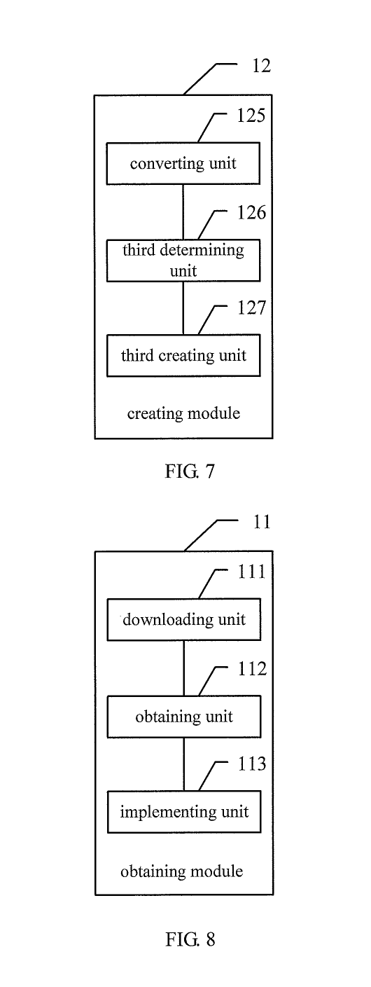

Furthermore, a structure shown in FIG. 8 may be adopted by the obtaining module 11, which comprises: a downloading unit 111, which is configured to download, from the server, the data to share stored in the server; an obtaining unit 112, which is configured to obtain a character string for the data to share, wherein the character string is allocated by the server; and an implementing unit 113, which is configured to obtain a compressed character string by implementing a binary compression on the character string, wherein the compressed character string serves as the identification information of the data to share.

In one embodiment of the invention, by converting the identification information corresponding to the data to share into an audio signal and playing it to other terminals so as to accomplish transmission of the identification information of the data to share, data sharing may be performed anytime and anywhere as long as a connection with the server has been established, without the need of establishing a bluetooth or other connections between the terminals or the need of installing any communication applications. Therefore, data such as audio/video, image/photograph, and article/fiction can be shared in a real-time, fast, and convenient way.

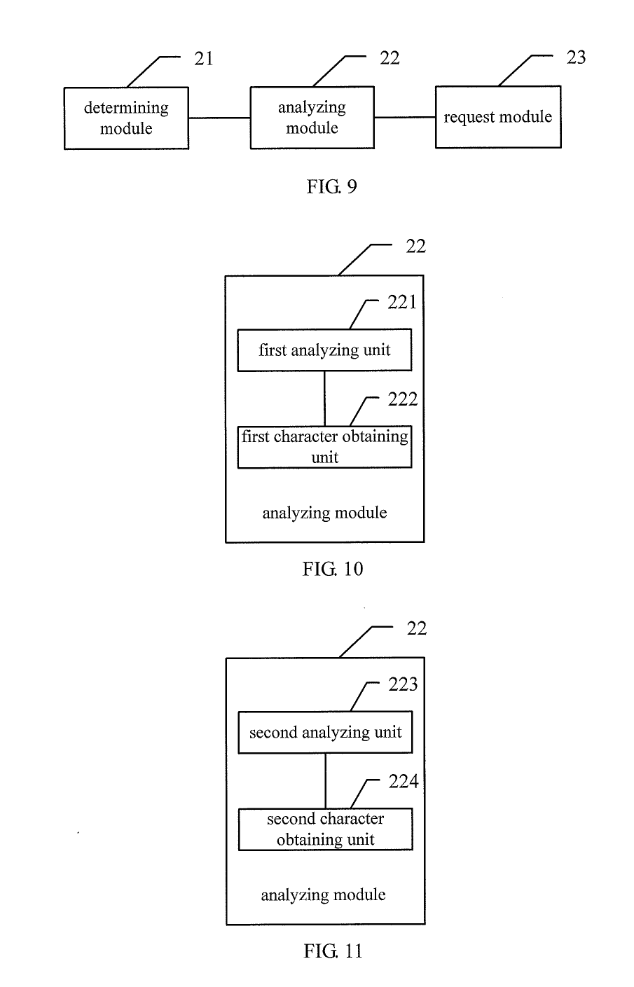

As shown in FIG. 9, it is a structure diagram of a terminal for implementing data sharing according to yet another embodiment of the invention. The terminal for implementing data sharing may be handsets, computers and other terminals having microphones and other sound collecting modules. The terminal serving as a receiver for implementing data sharing comprises: a determining module 21, which is configured to determine at least one identification frequency of an identification audio signal in sequence when collecting the identification audio signal; an analyzing module 22, which is configured to analyze and determine identification information carried by the identification audio signal according to the at least one identification frequency and a preset frequency allocation rule; and a request module 23, which is configured to transmit a download request carrying the analyzed and determined identification information to a server storing data to share, and download the data to share corresponding to the identification information from the server.

The determined identification information comprises at least one identification character. The analyzing module 22 may be a structure shown in FIG. 10, and the analyzing module comprises: a first analyzing unit 221, which is configured to determine in sequence the at least one identification character each corresponding to a respective one of the at least one identification frequency according to a one-to-one mapping relationship between characters and frequencies in the preset frequency allocation rule; and a first character obtaining unit 222, which is configured to obtain the identification information according to the at least one identification character.

Optionally, the analyzing module 22 may be a structure shown in FIG. 11, and the analyzing module comprises: a second analyzing unit 223, which is configured to determine in sequence at least one identification frequency number each corresponding to a respective one of the at least one identification frequency according to frequency numbers in the preset frequency allocation rule, obtain at least one identification character number each by making a sum of at least two of the identification frequency numbers, and determine in sequence at least one identification characters each corresponding to a respective one of the at least one identification character number according to a one-to-one mapping relationship between characters and character numbers in the preset frequency allocation rule; and a second character obtaining unit 224, which is configured to obtain the identification information according to the at least one identification character.

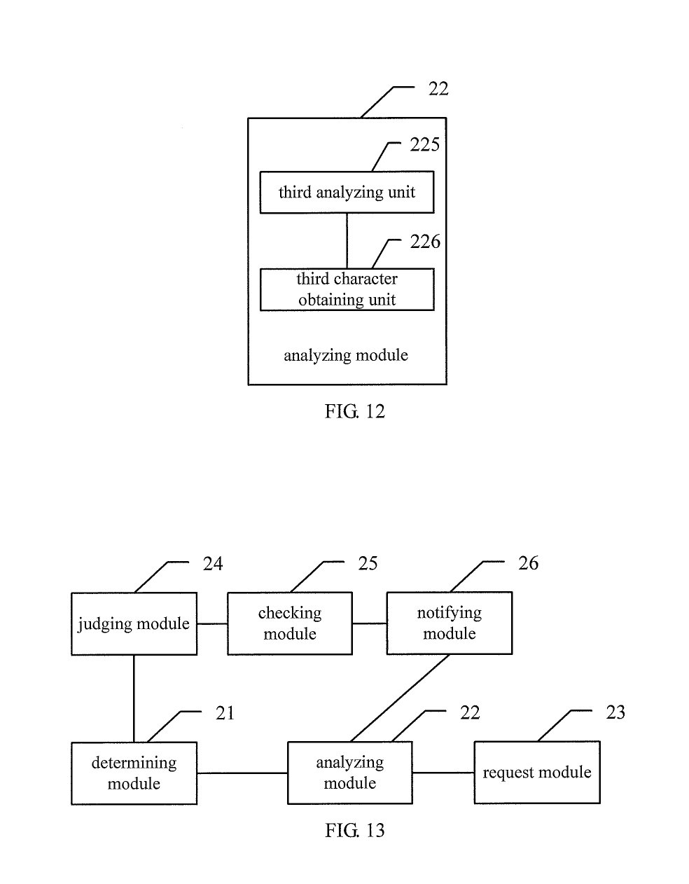

Still optionally, the analyzing module 22 may be a structure shown in FIG. 12, and the analyzing module comprises: a third analyzing unit 225, which is configured to determine in sequence at least one identification frequency number each corresponding to a respective one of the at least one identification frequency according to a one-to-one mapping relationship between frequencies and frequency numbers in the preset frequency allocation rule, convert the at least one identification frequency number into at least one binary code each corresponding to a respective one of the at least one identification frequency number, obtain a binary code string by combining the at least one binary code, divide the binary code string into at least one portion of the binary code string according to a preset decoding number threshold value, convert the at least one portion of the binary code string into at least one identification character number each corresponding to a respective one of the at least one portion of the binary code string, and determine in sequence at least one identification character each corresponding to a respective one of the at least one identification character number according to a one-to-one mapping relationship between characters and character numbers in the preset frequency allocation rule; and a third character obtaining unit 226, which is configured to obtain the identification information according to the at least one identification character.

Furthermore, the analyzing module 22, which is configured to obtain a decompressed character string by implementing a binary decompression on a character string obtained by combining the at least one identification character, wherein the decompressed character string serves as the character identification information when the analyzing module obtains the identification information according to the at least one identification character.

It should be noted that the analyzing module 22 in the terminal for implementing data sharing may comprise a structure shown above in any one of FIGS. 10-12. In this way, the user at the receiver can choose corresponding functional units of the analyzing module 22 according to the transmission manner of the transmitter to accurately accomplish the conversion from frequencies into characters.

Furthermore, as shown in FIG. 13, it is a structure diagram of a terminal for implementing data sharing according to yet another embodiment of the invention. The terminal for implementing data sharing comprises a determining module 21, an analyzing module 22 and a request module 23 of the embodiment correspondingly shown in FIG. 9. In the embodiment of the invention, the terminal for implementing data sharing further comprising: a judging module 24, which is configured to judge whether an identifier is obtained after analyzing a frequency segment of an identifier bit in the at least one identification frequency, the identifier being used for identifying that an audio signal is the identification audio signal carrying the identification information; a checking module 25, which is configured to obtain check bit information by analyzing one of the at least one identification frequency that corresponds to the check bit when the identifier is obtained, and check the identification audio signal by a preset checksum algorithm and by the check bit information; and a notifying module 26, which is configured to notify the analyzing module 22 when the check succeeds.

According to one embodiment, the receiver is able to analyze the received audio data and to download the data to share corresponding to the identification information at the server after the receiver obtains the identification information. In this way, data sharing may be performed anytime and anywhere as long as a connection with the server has been established, without the need of establishing a bluetooth or other connections between the terminals or the need of installing any communication applications. Therefore, data such as audio/video, image/photograph, and article/fiction can be shared in a real-time, fast, and convenient way.

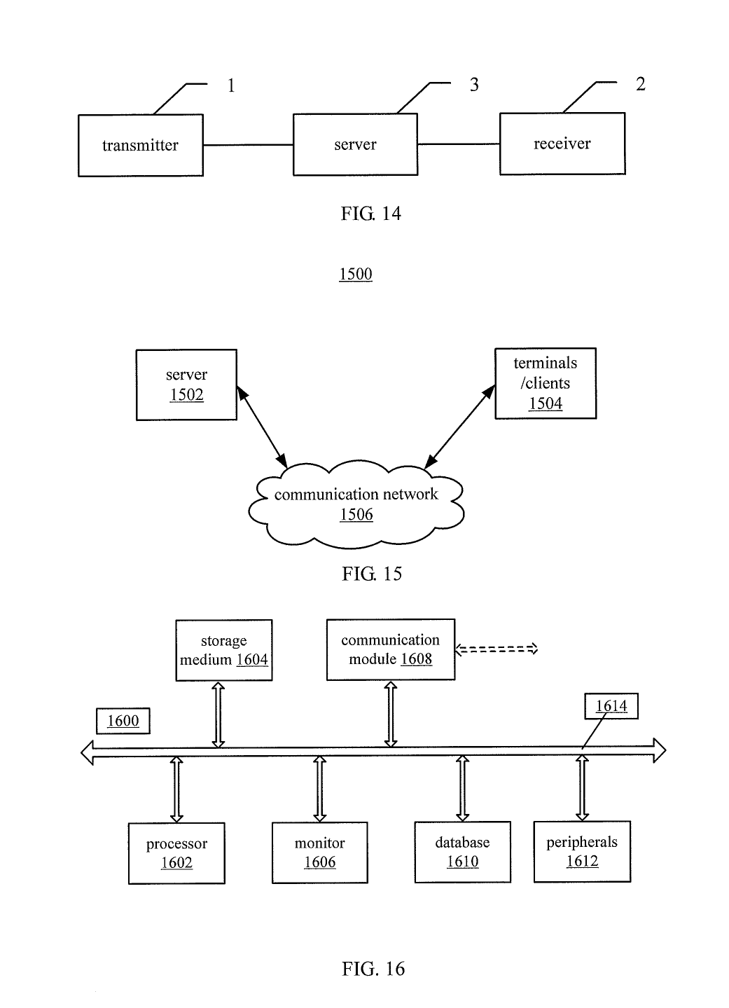

As shown in FIG. 14, it is a structure diagram of a system for implementing data sharing according to yet another embodiment of the invention. According to one embodiment, the system for implementing data sharing comprises a transmitter 1, a receiver 2, and a server 3, wherein: the transmitter 1, which is configured to obtain identification information of data to share stored in a server 3, allocate at least one identification frequency for the identification information according to a preset frequency allocation rule, and create and play an identification audio signal according to the at least one identification frequency; the receiver 2, which is configured to obtain the identification information by analyzing the identification audio signal according to the preset frequency allocation rule after the receiver 2 collects the identification audio signal, and transmit a download request carrying the identification information to the server 3; and the server 3, which is configured to search target data corresponding to the identification information carried in the download request when the server 3 receives the download request, and transmit the searched target data to the receiver 2.

Specifically, the transmitter 1 may comprise the terminals for implementing data sharing corresponding to FIGS. 4-7, and may be configured to perform the method of creating an identification audio signal and playing the identification audio signal in the embodiment corresponding to FIG. 1. The receiver 2 may comprise the terminals for implementing data sharing corresponding to FIGS. 8-11 or FIG. 12, and may be configured to perform the method of downloading, at the server, the data to share after receiving the identification audio signal in the embodiment corresponding to FIG. 2. The server 3 may search for data, such as audio/video, image/photograph, article/fiction, that correspond to the identification information by way of searching, and transmit the data to the receiver 2 to accomplish data sharing through internet or other networks.

According to one embodiment, the identification information corresponding to the data to share can be played as an audio signal to other terminals, so as to accomplish transmission of the identification information of the data to share. In this way, data sharing may be performed anytime and anywhere as long as a connection with the server has been established, without the need of establishing a bluetooth or other connections between the terminals or the need of installing any communication applications. Therefore, data such as audio/video, image/photograph, and article/fiction can be shared in a real-time, fast, and convenient way.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention. Therefore, the scope of the present invention shall be subject to be appended claims.

1. A method for implementing data sharing, comprising the steps of:
obtaining identification information of data to share stored in a server;
allocating at least one identification frequency for the identification information according to a preset frequency allocation rule, creating an identification audio signal according to the at least one identification frequency; and
playing the created identification audio signal, so that a receiver downloads the data to share from the server according to the identification information in the identification audio signal after the receiver collects the identification audio signal.

2. The method according to claim 1, wherein the obtained identification information comprises at least one identification character; and wherein the step of allocating the at least one identification frequency for the identification information according to the preset frequency allocation rule, creating the identification audio signal according to the at least one identification frequency comprises:
determining at least one identification frequency each corresponding to a respective one of the at least one identification character according to a one-to-one mapping relationship between characters and frequencies in the preset frequency allocation rule to obtain frequency information of the identification information; and
creating the identification audio signal according to the obtained frequency information.

3. The method according to claim 1, wherein the obtained identification information comprises at least one identification character; and wherein the step of allocating the at least one identification frequency for the identification information according to the preset frequency allocation rule, creating the identification audio signal according to the at least one identification frequency comprises:
allocating a combined identification frequency for each of the at least one identification character according to a mapping relationship between character numbers and frequency numbers in the preset frequency allocation rule to obtain frequency information of the identification information, the combined identification frequency being obtained by combining at least two frequencies; and
creating the identification audio signal according to the obtained frequency information.

4. The method according to claim 1, wherein the obtained identification information comprises at least one identification character; and wherein the step of allocating the at least one identification frequency for the identification information according to the preset frequency allocation rule, creating the identification audio signal according to the at least one identification frequency comprises:
obtaining at least one identification character number each corresponding to a respective one of the at least one identification character according to a one-to-one mapping relationship between characters and character numbers in the preset frequency allocation rule, and then obtaining a binary code string by combining at least one binary code each converted by a respective one of the at least one identification character number;
dividing the binary code string into at least one portion of the binary code string according to a preset coding number threshold value, and converting the at least one portion of the binary code string into at least one identification frequency number each corresponding to a respective one of the at least one portion of the binary code string;
obtaining frequency information of the identification information according to the at least one identification frequency number and frequency numbers in the preset frequency allocation rule; and
creating the identification audio signal according to the obtained frequency information.

5. The method according to claim 1, wherein obtaining the identification information of data to share stored in the server comprises:
downloading, from the server, the data to share stored in the server;
obtaining a character string, which is allocated by the server, for the data to share; and
obtaining a compressed character string by implementing a binary compression on the character string, wherein the compressed character string serves as the identification information of the data to share.

6. The method according to claim 2, wherein creating the identification audio signal according to the obtained frequency information comprises:
creating the identification audio signal according to a preset audio format and the obtained frequency information, wherein:
the preset audio format comprises an identifier, an information bit, and a check bit, the identifier is used to identify that an audio signal is the identification audio signal carrying the identification information, the information bit is used to carry the frequency information, and the check bit is used for error correction check for the identification audio signal.

7. The method according to claim 6, wherein:
the identifier is set in a head section of the identification audio signal; or
the identifier is divided into two sections, which are respectively set in the head section and the tail section of the identification audio signal; or
the identifier is divided into two sections, which are respectively set in the head section and the middle section of the identification audio signal.

8. A method for implementing data sharing, comprising the steps of:
determining at least one identification frequency of an identification audio signal in sequence when collecting the identification audio signal;
analyzing and determining identification information carried by the identification audio signal according to the at least one identification frequency and a preset frequency allocation rule; and
transmitting a download request carrying the analyzed and determined identification information to a server storing data to share, downloading the data to share corresponding to the identification information from the server.

9. The method according to claim 8, wherein the determined identification information comprises at least one identification character, and wherein the step of analyzing and determining identification information carried by the identification audio signal according to the at least one identification frequency and the preset frequency allocation rule comprises:
determining in sequence the at least one identification character each corresponding to a respective one of the at least one identification frequency according to a one-to-one mapping relationship between characters and frequencies in the preset frequency allocation rule; and
obtaining the identification information according to the at least one identification character.

10. The method according to claim 8, wherein the verified identification information comprises at least one identification character, and wherein the step of analyzing and determining identification information carried by the identification audio signal according to the at least one identification frequency and the preset frequency allocation rule comprises:
determining in sequence at least one identification frequency number each corresponding to a respective one of the at least one identification frequency according to frequency numbers in the preset frequency allocation rule;
obtaining at least one identification character number each by making a sum of at least two of the identification frequency numbers, and determining in sequence at least one identification characters each corresponding to a respective one of the at least one identification character number according to a one-to-one mapping relationship between characters and character numbers in the preset frequency allocation rule; and
obtaining the identification information according to the at least one identification character.

11. The method according to claim 8, wherein the verified identification information comprises at least one identification character, and wherein the step of analyzing and determining identification information carried by the identification audio signal according to the at least one identification frequency and the preset frequency allocation rule comprises:
determining in sequence at least one identification frequency number each corresponding to a respective one of the at least one identification frequency according to a one-to-one mapping relationship between frequencies and frequency numbers in the preset frequency allocation rule;
converting the at least one identification frequency number into at least one binary code each corresponding to a respective one of the at least one identification frequency number, obtaining a binary code string by combining the at least one binary code, dividing the binary code string into at least one portion of the binary code string according to a preset decoding number threshold value, and converting the at least one portion of the binary code string into at least one identification character number each corresponding to a respective one of the at least one portion of the binary code string;
determining in sequence at least one identification character each corresponding to a respective one of the at least one identification character number according to a one-to-one mapping relationship between characters and character numbers in the preset frequency allocation rule; and
obtaining the identification information according to the at least one identification character.

12. The method according to claim 9, wherein obtaining the identification information according to the at least one identification character comprises:
obtaining a decompressed character string by implementing a binary decompression on a character string obtained by combining the at least one identification character, wherein the decompressed character string serves as the character identification information.

13. The method according to claim 12, wherein, before the step of analyzing and determining identification information carried by the identification audio signal according to the at least one identification frequency and a preset frequency allocation rule, the method further comprises:
judging whether an identifier is obtained after analyzing a frequency segment of an identifier bit in the at least one identification frequency, the identifier being used for identifying that an audio signal is the identification audio signal carrying the identification information;
if the identifier is obtained, obtaining check bit information by analyzing one of the at least one identification frequency that corresponds to the check bit, and checking the identification audio signal by a preset checksum algorithm and by the check bit information; and
if the check succeeds, performing the step of analyzing and determining identification information carried by the identification audio signal according to the at least one identification frequency and a preset frequency allocation rule.

14. (canceled)

15. A terminal for implementing data sharing, comprising:
an obtaining module, which is configured to obtain identification information of data to share stored in a server;
a creating module, which is configured to allocate at least one identification frequency for the identification information according to a preset frequency allocation rule, and create an identification audio signal according to the at least one identification frequency; and
a playing module, which is configured to play the created identification audio signal, so that a receiver downloads the data to share from the server according to the identification information in the identification audio signal after the receiver collects the identification audio signal.

16. The terminal according to claim 15, wherein the obtained identification information comprises at least one identification character, and the creating module comprises:
a first determining unit, which is configured to determine at least one identification frequency each corresponding to a respective one of the at least one identification character according to a one-to-one mapping relationship between characters and frequencies in the preset frequency allocation rule to obtain frequency information of the identification information; and
a first creating unit, which is configured to create the identification audio signal according to the obtained frequency information.

17. The terminal according to claim 15, wherein the obtained identification information comprises at least one identification character, and the creating module comprises:
a second determining unit, which is configured to allocate a combined identification frequency for each of the at least one identification character according to a mapping relationship between character numbers and frequency numbers in the preset frequency allocation rule to obtain frequency information of the identification information, the combined identification frequency being obtained by combining at least two frequencies; and
a second creating unit, which is configured to create the identification audio signal according to the obtained frequency information.

18. The terminal according to claim 15, wherein the obtained identification information comprises at least one identification character, and the creating module comprises:
a converting unit, which is configured to obtain at least one identification character number each corresponding to a respective one of the at least one identification character according to a one-to-one mapping relationship between characters and character numbers in the preset frequency allocation rule, then obtain a binary code string by combining at least one binary code each converted by a respective one of the at least one identification character number, divide the binary code string into at least one portion of the binary code string according to a preset coding number threshold value, and convert the at least one portion of the binary code string into at least one identification frequency number each corresponding to a respective one of the at least one portion of the binary code string;
a third determining unit, which is configured to obtain frequency information of the identification information according to the at least one identification frequency number and frequency numbers in the preset frequency allocation rule; and
a third creating unit, which is configured to create the identification audio signal according to the obtained frequency information.

19. The terminal according to claim 15, wherein the obtaining module comprises:
a downloading unit, which is configured to download, from the server, the data to share stored in the server;
an obtaining unit, which is configured to obtain a character string for the data to share, wherein the character string is allocated by the server; and
an implementing unit, which is configured to obtain a compressed character string by implementing a binary compression on the character string, wherein the compressed character string serves as the identification information of the data to share.

20. The terminal according to claim 16, wherein:
the creating module, which is configured to create the identification audio signal according to a preset audio format and the obtained frequency information when the creating module creates the identification audio signal according to the obtained frequency information, wherein:
the preset audio format comprises an identifier, an information bit, and a check bit, the identifier is used to identify that an audio signal is the identification audio signal carrying the identification information, the information bit is used to carry the frequency information, and the check bit is used for error correction check for the identification audio signal.

21. (canceled)

22. (canceled)

23. (canceled)

24. (canceled)

25. (canceled)

26. (canceled)

27. (canceled)
